(19) United States
(12) Patent Application Publication
(10) Pub. No.: US 2005/0218043 A1
(43) Pub. Date: Oct. 6, 2005

(54) Magnetic separator for air slide conveyors

(76) Inventor: Rano R. Wells II, Franklin, WI (US)

Correspondence Address: JANSSON, SHUPE & MUNGER & ANTARAMIAN, LTD, 245 MAIN STREET, RACINE, WI, 53403, US

(21) Appl. No.: 10/814,951

(22) Filed: Mar. 31, 2004

(51) Int. Cl. B03C 1/30

(52) U.S. Cl. 209/39; 209/223.1

(57) ABSTRACT

A material-conveying air slide including a non-magnetic duct shell, a magnet mounted on the outside of the duct shell, and a steel pole piece protruding from the magnet through the duct shell into the duct. The pole piece modifies the magnetic field such that an effective field substantially fills a cross-section of the duct at the pole piece.

### FIELD OF THE INVENTION

This invention is related generally to material handling devices, and, more particularly, to air slide conveyors and to magnetic separation of material.

### BACKGROUND OF THE INVENTION

In the handling or conveyance of materials such as plastic, cement powder or other pulverized material, one useful way to transport such material over long distances within a process plant is through the use of a conveying system called an air slide. By example, air slide conveyors are manufactured by F. L. Smidth: Fuller Bulk Handling Division, Bethlehem, Pa. 18016, USA. In the past, pulverized materials being conveyed by air slide conveyors have had tramp iron contaminants which are not easily removed and which are problematic.

An air slide conveyor consists of a top section through which the material being transported flows, a bottom section through which air flows, and a porous membrane separating these two sections. Air flows from the bottom section through the membrane and “fluidizes” the material being conveyed in the top section, causing the material flowing in the top section to behave like a liquid. The semi-liquid state of the material enables it to flow under the influence of gravity even when the air slide is only sloped a few degrees from horizontal.

The technical field of magnetic separation of pieces of magnetic material from other materials is long-established. Two applications in particular are common: the removal of magnetic material (primarily iron-containing material) from streams of waste and removal of unwanted pieces of material commonly called tramp iron, from streams of processed material product such as recycled plastic.

When magnetic separation is used to remove magnetic material from a stream of pulverized product, this is typically done for two reasons. First, the removal of unwanted tramp iron from the stream of product increases the quality of the final product for products for which such purity is required. Secondly, if there is further processing which takes place on the product flowing downstream of the magnetic removal of tramp iron, such removal protects the downstream equipment from any damage which might occur therefrom.

The ability of such fluidized material to flow easily with only slight drops in elevation is one of the advantages of air slide conveyors. However, magnetic separators which might be applied to the removal of tramp iron from a stream of pulverized material typically require a larger drop in elevation than is appropriate for an air slide. On an ordinary conveyor belt, for example, material transported on the belt can be directed over a magnetic roller at the end of the conveyor. The tramp iron being removed is attracted to the roller, thus staying on the belt longer than the material being conveyed and falls from the belt at a different location from the stream of conveyed material, thereby effecting separation. U.S. Pat. No. 5,626,233 is an example of such a conveyor belt/magnetic drum separator device. Such separation in connection with an air slide would require a transition from the air slide conveyor to a belt conveyor and the attendant unwanted change in elevation.

There is a need for a magnetic removal apparatus which can operate effectively with an air slide conveyor. However, effective magnetic removal of tramp iron from the stream of material flowing in an air slide conveyor requires filling the region in which material is flowing with a magnetic field of sufficient strength to remove both large and small pieces of tramp iron and to achieve that field strength in a cost-effective manner. While magnetic removal of tramp iron could be achieved by placing a very strong magnet over the stream of material product, magnets which are of sufficient strength to accomplish adequate removal of tramp iron in such material flow through an air slide are much larger than would be considered cost-effective.

### OBJECTS OF THE INVENTION

It is an object of this invention to provide an improved air slide conveyor which efficiently removes tramp iron from the flow of the material.

Another object of this invention is to provide an improved air slide conveyor that has an effective magnetic field substantially filling a cross-section of the material flow duct.

Another object of this invention is to provide material-conveying apparatus for the removal of tramp iron from the flow of the material being conveyed such that the cost of the magnet required is minimized.

Another object of the invention is to provide a tramp iron removal device for conveyed material which minimizes the elevation drop required for such removal.

Another object of the invention is to provide a tramp iron removal device for conveyed material which prevents conveyed material from hanging up on the device.

Another object of the invention is to provide material-conveying apparatus for the removal of tramp iron from the flow of the material being conveyed which can be easily inserted into an air slide as a section of the air slide.

Another object of the invention is to provide air slide material-conveying apparatus for the removal of tramp iron from the flow of the material being conveyed which reliably ensures the quality of the material being conveyed.

Another object of the invention is to provide magnetic separation in air slide conveyors without inserting sections requiring elevation drops that negate a principal advantage of air slides—i.e., long conveyance with minimal elevation drop.

Another object of the invention is to provide air slide material-conveying apparatus for the removal of tramp iron from the flow of the material being conveyed which reliably protects the process equipment downstream of the apparatus from damage.

These and other objects of the invention will be apparent from the following descriptions and from the drawings.

### SUMMARY OF THE INVENTION

The invention is material-conveying apparatus which separates tramp iron from the material being conveyed in the apparatus. In particular, the invention is an improvement in air slide conveyors overcoming the problems referred to above. The invention is also an improved magnetic separator for material-flow apparatus.

The air slide apparatus of this invention includes: (1) a duct shell made of non-magnetic material and defining a duct; (2) a porous membrane mounted across the inside of the duct in a plane substantially parallel to the general flow of conveyed material and dividing the duct into a material side and an air-supply side; (3) an air-supply connection secured with respect to the duct shell to increase pressure in the air-supply side such that air flowing from the air-supply side to the material side through the porous membrane assists movement of conveyed material through the duct; (4) a magnet mounted on the outside of the duct shell; and (5) a steel pole piece protruding from the magnet through the duct shell into the duct. The pole piece modifies the magnetic field such that an effective field substantially fills a cross-section of the duct at the pole piece.

In a preferred embodiments of the invention, the magnet is an electromagnet. The duct shell is preferably made of stainless steel, and the pole piece preferably includes a tapered leading edge to prevent the conveyed material from hanging up on the pole piece. In preferred embodiments of the inventive apparatus, the duct shell has a substantially rectangular cross-section.

Another aspect of this invention involves material-conveying equipment for separating tramp iron from the material being conveyed in ducts, the equipment having improved magnetic separation apparatus. Such material-conveying equipment includes: (1) a non-magnetic duct shell that defines a duct; (2) a magnet mounted on the outside of the duct shell; and (3) a steel pole piece protruding from the magnet through the duct shell into the duct. These elements are configured in the material-conveying equipment such that the pole piece modifies the magnetic field in order that an effective field substantially fills a cross-section of the duct at the pole piece.

### BRIEF DESCRIPTION OF THE DRAWINGS

The drawings illustrate preferred embodiments which include the above-noted characteristics and features of the invention. The invention will be readily understood from the descriptions and drawings. In the drawings:

FIG. 1 is an end view of one embodiment of the material-conveying apparatus of this invention.

FIG. 2 is a detailed end view of the embodiment of FIG. 1.

FIG. 3 is a detailed side view of the embodiment of FIG. 1.

FIG. 4 is an end view plot representing the magnetic field lines in a cross-section of duct without the pole piece.

FIG. 5 is an end view plot representing the magnetic field lines in a cross-section of duct with the pole piece.

### DETAILED DESCRIPTION OF PREFERRED EMBODIMENTS

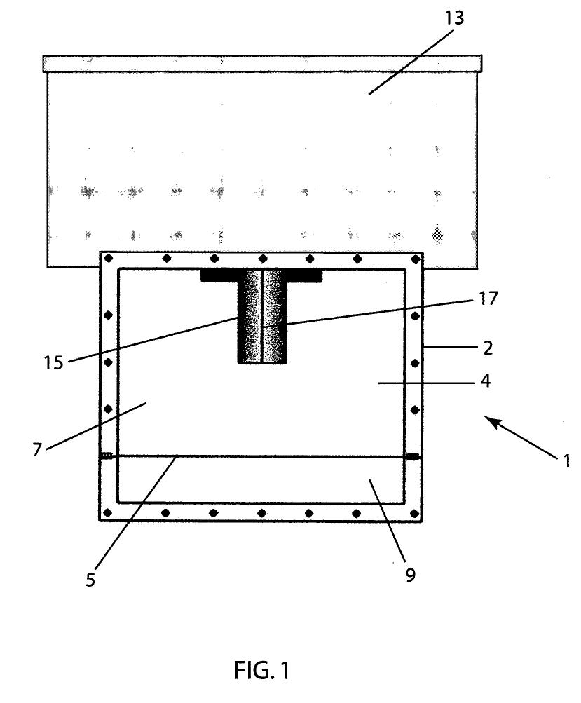

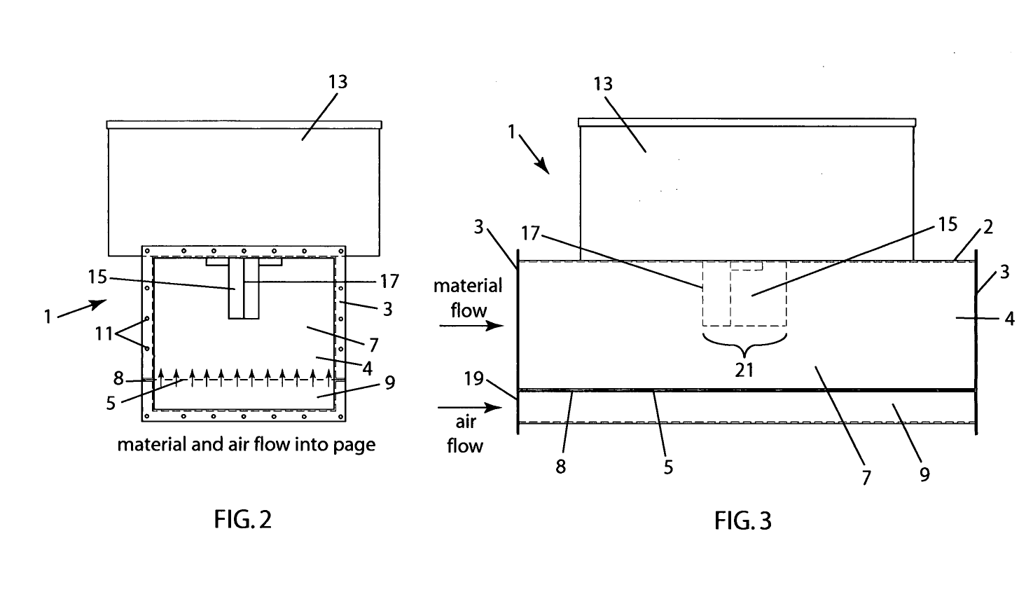

FIG. 1 shows an end view of a preferred material-conveying air slide apparatus 1 in accordance with this invention. FIGS. 2 and 3 are more detailed drawings (end and side views) of air slide apparatus 1. In such figures, apparatus 1 is an air slide conveyor section configured to be inserted between two other air slide conveyor sections (not shown), which together form a lengthy air slide conveyor.

A stainless steel duct shell 2 defines a duct 4 through which the material being conveyed and the air supplied to the apparatus both flow. A porous membrane 5 divides duct 4 into a material side 7 and an air-supply side 9. Membrane 5 is supported between two longitudinal flanges 8 in duct shell 2. Duct shell 2 is connected at each end to sections of the larger air slide conveyor (not shown) by two flanges 3 (one at each end of duct shell 2) using fasteners in mounting holes 11 (two only are indicated as elements 11). Air is supplied to air-supply side 9 at the upstream end of duct 4, indicated in FIG. 3 by the arrows showing the direction of material and air flow through duct 4.

The operation of an air slide conveyor is well known to those skilled in the art of material handling. Air supplied to air-supply side 9 flows through the openings in membrane 5 as shown by the series of arrows in FIG. 2. The flow of air through membrane 5 acts to fluidize the material being conveyed, causing the material to flow like a liquid, thereby allowing the material to flow under the influence of gravity in a nearly horizontal conveyor.

An electromagnet 13 is mounted on the top of duct shell 2 to create a magnetic field to pull tramp iron (unwanted pieces of iron) from the flow of material being conveyed through material side 7 of duct 4. A pole piece 15 is mounted to electromagnet 13 and extends through the top of duct shell 2 into material side 7 of duct 4. Pole piece 15 is wedged-shaped, having a tapered leading edge 17. The purpose of leading edge 17 is to prevent material which is flowing through material side 7 of duct 4 from hanging up on pole piece 15.

Tramp iron removed from the flow of material is attracted to pole piece 15 and held in place by magnetic force. When it is necessary to remove accumulated tramp iron from pole piece 15, electromagnet 13 is de-energized, and the tramp iron falls into a catch pan (not shown) or other receptacle temporarily placed in apparatus 1 to withdraw captured tramp iron.

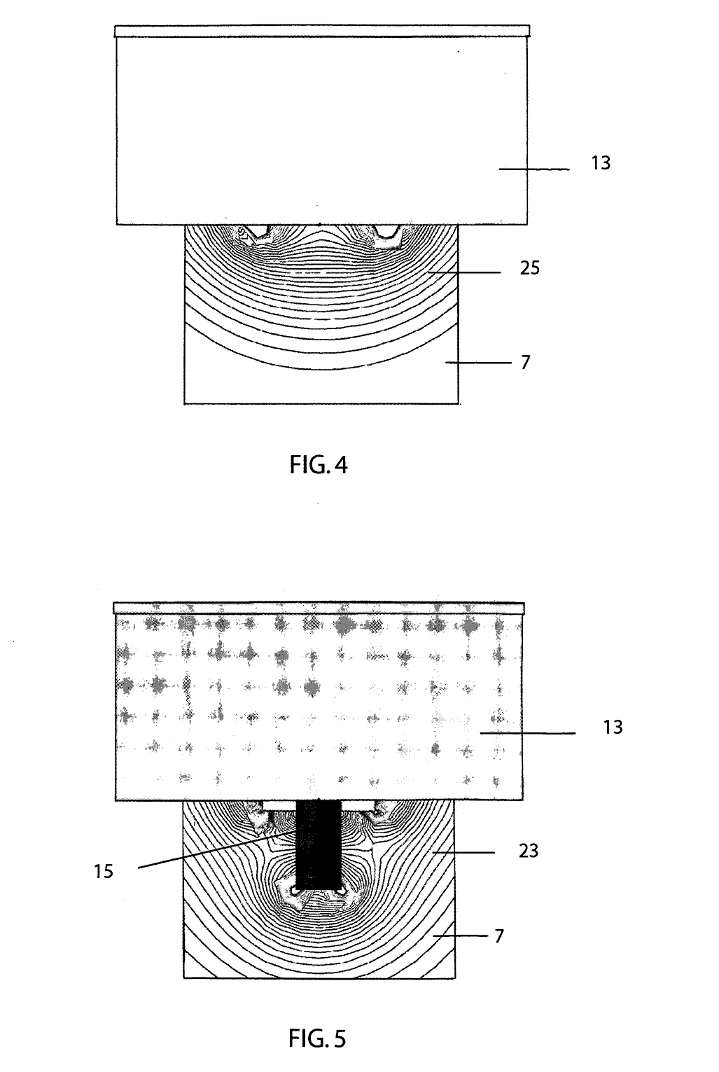

Pole piece 15 defines a cross-section region 21 in material side 7 at which the magnetic field is the strongest and at which the tramp iron is most effectively removed. FIG. 5 is a plot of the magnetic field 23 produced by electromagnet 13 within material side 7 of duct 4 at a cross-section region 21. FIG. 4 serves as a point of comparison, showing a magnetic field 25 produced by electromagnet 13 without the use of pole piece 15, thereby illustrating the performance advantage of the inventive apparatus. FIGS. 4 and 5 are plots produced by numerical simulation of the magnetic fields 25 and 23, respectively.

Magnetic field 23 shown in FIG. 5 substantially fills material side 7, thereby creating a field which is effective at removing tramp iron from throughout material side 7 at cross-section region 21. By comparison, magnetic field 25 shown in FIG. 4, created without the use of pole piece 15, is not sufficient to be effective throughout material side 7 at cross-section region 21. In order to create a suitably effective magnetic field in this region without pole piece 15, a much larger electromagnet than electromagnet 13 is required. The additional cost of such a large electromagnet is far greater than the cost of pole piece 15, making inventive apparatus 1 a cost-effective solution to tramp iron removal in an air slide conveyor.

While the principles of this invention have been described in connection with a specific embodiment, it should be understood clearly that this description is made only by way of example and is not intended to limit the scope of the invention.

1. A material-conveying apparatus for separating tramp iron from the material conveyed, comprising:
a duct shell made of non-magnetic material and defining a duct;
a porous membrane mounted across the inside of the duct in a plane substantially parallel to the general flow of conveyed material and dividing the duct into a material side and an air-supply side;
an air-supply connection secured with respect to the duct shell to increase pressure in the air-supply side such that air flowing from the air-supply side to the material side through the porous membrane assists movement of conveyed material through the duct;
a magnet mounted on the outside of the duct shell; and
a steel pole piece protruding from the magnet through the duct shell into the duct,
whereby the pole piece modifies the magnetic field such that an effective field substantially fills a cross-section of the duct at the pole piece.

2. The material-conveying apparatus of claim 1 wherein the magnet is an electromagnet.

3. The material-conveying apparatus of claim 1 wherein the duct shell is of stainless steel.

4. The material-conveying apparatus of claim 1 wherein the pole piece includes a tapered leading edge, whereby conveyed material does not hang up on the pole piece.

5. The material-conveying apparatus of claim 1 wherein the duct shell has a substantially rectangular cross-section.

6. A material-conveying apparatus for separating tramp iron from the material conveyed, comprising:
a duct shell made of non-magnetic material and defining a duct;
a magnet mounted on the outside of the duct shell; and
a steel pole piece protruding from the magnet through the duct shell into the duct,
whereby the pole piece modifies the magnetic field such that an effective field substantially fills a cross-section of the duct at the pole piece.

7. The material-conveying apparatus of claim 6 wherein the magnet is an electromagnet.

8. The material-conveying apparatus of claim 6 wherein the duct shell is of stainless steel.

9. The material-conveying apparatus of claim 6 wherein the pole piece includes a tapered leading edge, whereby conveyed material does not hang up on the pole piece.

10. The material-conveying apparatus of claim 6 wherein the duct shell has a substantially rectangular cross-section.
